(19) United States
(12) Patent Application Publication
(10) Pub. No.: US 2025/0214778 A1
(43) Pub. Date: Jul. 3, 2025

(54) SORTING STATION

(71) Applicant: Murata Machinery, Ltd., Kyoto-shi, Kyoto (JP)

(72) Inventors: Tsuyoshi NAKANO, Inuyama-shi (JP); Shigeo DOI, Tokyo (JP); Takayuki UCHIDA, Tokyo (JP)

(21) Appl. No.: 18/850,172

(22) PCT Filed: Feb. 22, 2023
(86) PCT No.: PCT/JP2023/006593

§ 371 Date: Sep. 24, 2024

(30) Foreign Application Priority Data
Mar. 31, 2022 (JP) 2022-060152

(51) Int. Cl. B65G 1/137

(52) U.S. Cl. CPC B65G 1/1376; B65G 1/1375

(57) ABSTRACT

A sorting station where sorting work is performed by an operator on a conveyed item includes a lower buffer line including a first conveyance path to convey the conveyed item in one direction and including a work location where the operator performs sorting work, an upper buffer line including a second conveyance path above the first conveyance and including ends connected to a main conveyor to convey the conveyed item in one direction between the ends, the upper buffer line being above the first conveyance path, and a lifter to convey the conveyed item in a vertical direction to allow the conveyed item to be passed between the first conveyance path and the second conveyance path.

### BACKGROUND OF THE INVENTION

### 1. Field of the Invention

The present invention relates to sorting stations.

### 2. Description of the Related Art

For example, Japanese Unexamined Patent Publication No. 2007-153490 discloses a picking system configured to take out articles of types and quantities that match orders of shipping destinations from respective storage sections provided for each type of article, and consolidate and accommodate the articles in containers. The picking system includes a storage section in which articles are stored by type, a sorting station (sorting section) in which an operator sorts articles by type and quantity based on orders, and a conveyor configured to convey the articles between the storage section and the sorting station.

### SUMMARY OF THE INVENTION

In such a picking system, there are requests to place more storage shelves in which goods or containers accommodating goods are temporarily stored for performing sorting work at a sorting station, around a work location where the operator performs the sorting work, and to secure a wider space around the work location to improve the workability of the operator during the sorting work. However, in the conventional picking system described above, the work location for the operator and a main conveyor are often installed at the same level (e.g., at the same height), and the space around the work location is sometimes restricted by the main conveyor. Furthermore, there is a request to retain more conveyed item to be sorted in order to provide the sorting volume to keep up with the recent increase in the number of shipments.

Example embodiments of the present invention provide sorting stations each capable of securing a wide space around a work location where the operator performs sorting work, and capable of securing a storage capacity for conveyed item(s) to be sorted.

A sorting station according to an example embodiment of the present invention is a sorting station where sorting work is performed on a conveyed item by an operator, the sorting station including a lower buffer line including a loop-shaped first conveyance path to convey the conveyed item in one direction and including a work location where the operator performs sorting work, an upper buffer line provided above the first conveyance path and including a second conveyance path to convey the conveyed item from a first end to a second in one direction, the first end and the second end being connected to a main conveyor to convey the conveyed item, and a lifter to convey the conveyed item in a vertical direction to allow the conveyed item to be passed between the first conveyance path and the second conveyance path.

In this configuration, the conveyed item to be sorted can be stored separately in the upper buffer line and the lower buffer line, and thus the storage capacity for the conveyed item to be sorted can be secured. In this configuration, the work location where the operator performs the sorting work is provided on the lower buffer line, the lower buffer line is provided at a different level from the upper buffer line to which the main conveyor is connected, and thus the main conveyor is positioned at a different level (height position) from the work location. With this configuration, a space around the work location of the operator performing the sorting work is not restricted by the main conveyor, and thus the space around the work location can be more widely secured.

In a sorting station according to an example embodiment of the present invention, the second conveyance path may be U-shaped or substantially U-shaped in plan view viewed from the vertical direction. In this configuration, the storage capacity for the conveyed item can be secured while space saving is secured.

According to an example embodiment of the present invention, a driver of the lifter may be provided in an area surrounded by the loop-shaped first conveyance path. In this configuration, the driver can be positioned by using a dead space surrounded by the first conveyance path of a loop shape. With this configuration, it is possible to prevent the space around the work location from being restricted by the driver.

According to an example embodiment of the present invention, the upper buffer line may include a connecting conveyance path to connect a first relay section on a downstream side of the first end in the second conveyance path to a second relay section on a downstream side of the first relay section and on an upstream side of the second end in the second conveyance path. In this configuration, the conveyed item required for the sorting work by the operator can be conveyed again to the work location without being returned to the main conveyor. With this configuration, the throughput of the sorting work can be improved.

According to an example embodiment of the present invention, an operation of conveying in the conveyed item from the first conveyance path to the lifter and a conveyance operation of conveying out the conveyed item from the lifter to the first conveyance path may be executed simultaneously, and an operation of conveying in the conveyed item from the second conveyance path to the lifter and an operation of conveying out the conveyed item from the lifter to the second conveyance path may be executed simultaneously. In this configuration, a time required for conveying the conveyed item to the lifter and a time required for conveying the conveyed item from the lifter can be reduced.

According to an example embodiment of the present invention, a plurality of the upper buffer lines may be provided in a plurality of layers in the vertical direction. In this configuration, more articles can be stored in the sorting station.

According to an example embodiment of the present invention, the lifter may be provided to allow the plurality of conveyed items to be conveyed simultaneously the lifter may be provided to allow a plurality of the conveyed items to be conveyed simultaneously. In this configuration, a conveyance capacity of the lifter can be improved.

In a sorting station according to an example embodiment of the present invention, the work location in the lower buffer line may be provided below a portion of the main conveyor, the portion extending linearly in one direction the work location in the lower buffer line may be provided below a portion of the main conveyor, the portion extending linearly in one direction. In this configuration, a line of movement can be secured for the operator to move below the main conveyor disposed linearly.

According to example embodiments of the present invention, a space around a work location where an operator performs sorting work can be widely secured, and a storage capacity for conveyed items to be sorted can be secured.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a diagram of a sorting station according to an example embodiment of the present invention.

FIG. 2 is a perspective diagram of the sorting station of FIG. 1 viewed from another angle.

FIG. 3 is an enlarged perspective diagram illustrating portions of the first conveyance path and the second conveyance path.

FIG. 4 is a perspective diagram illustrating an area around the sorting station in FIG. 2.

FIG. 5 is a plan view of the second conveyance path.

FIG. 6 is a perspective diagram of the sorting station according to a modification of an example embodiment of the present invention.

FIG. 7 is a plan view of a picking system according to a modification of an example embodiment of the present invention.

### DETAILED DESCRIPTION OF THE EXAMPLE EMBODIMENTS

Sorting stations according to example embodiments is described below with reference to the drawings. In the description of the drawings, identical elements are marked with the same symbol and redundant explanations are omitted.

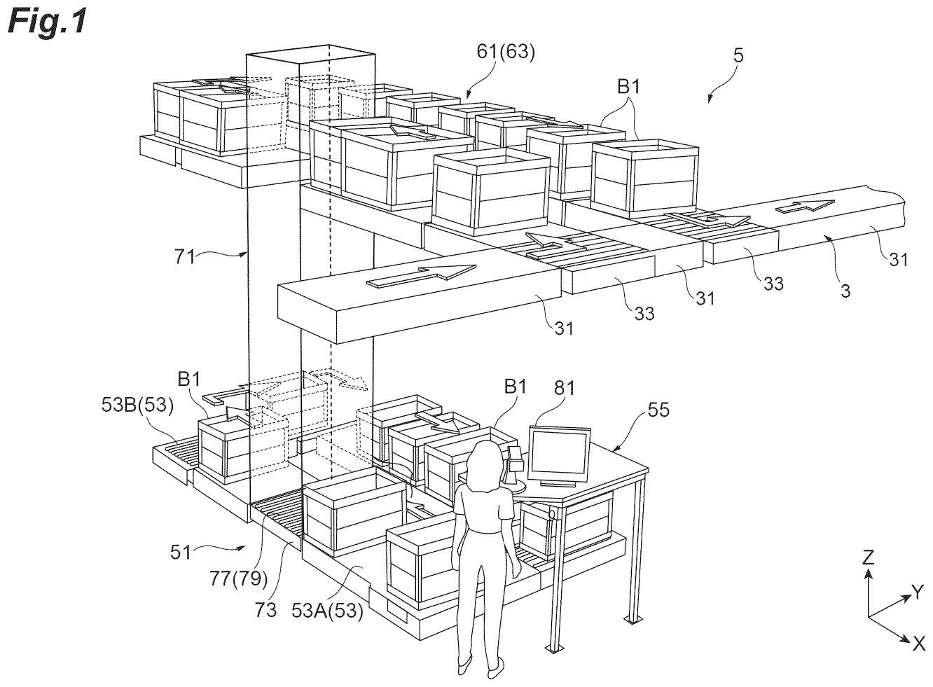

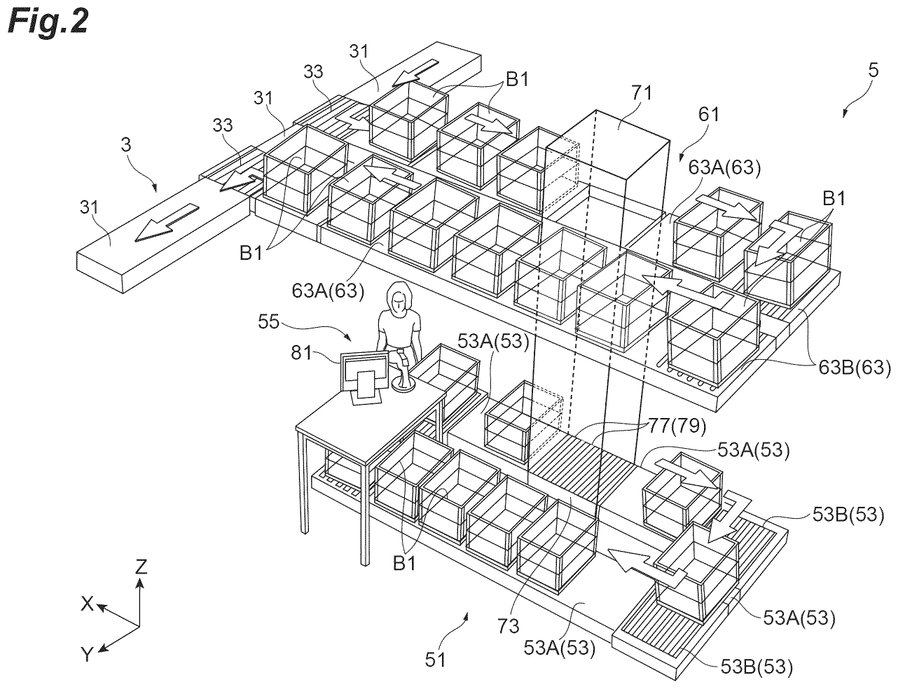

The sorting station 5 illustrated in FIGS. 1 and 2 is a system configured to support a sorting work (picking) for accommodating, in a delivery box (conveyed item) B1, articles of types and quantities that match orders of shipping destinations. More specifically, the sorting station 5 provides the operator with a work location 55 where the delivery box B1 conveyed by the main conveyor 3 is taken, and the articles of types and quantities that match orders of shipping destinations are accommodated in the taken delivery box B1. An example of an upstream process of the sorting work is a process of assembling the delivery box B1 that can be folded into a box shape, and an example of a downstream process of the sorting work is a process of transshipping the articles accommodated in the delivery box B1 into a cardboard box for delivery.

The main conveyor 3 conveys the delivery box B1 conveyed from the upstream process to each sorting station 5 and also conveys the delivery box B1 carried out from each sorting station 5 to the downstream process. The main conveyor 3 conveys the delivery box B1 in one direction. The type of the main conveyor 3 is not particularly limited and may be configured by combining a plurality types of conveyors with each other. The main conveyor 3 of the present example embodiment includes, for example, a main conveyance roller 31 and a branch conveyance roller 33.

The main conveyance roller 31 is a roller conveyor that supports the bottom surface of the delivery box B1 from below and conveys the delivery box B1 in one direction. The branch conveyance roller 33 is disposed at a connection portion with respect to the second conveyance path 63 of the sorting station 5, which will be described in detail later. The branch conveyance roller 33 conveys the delivery box B1 in the above one direction and also conveys the delivery box B1 in a direction orthogonal to the above one direction (X direction). In other words, the branch conveyance roller 33 can carry in and carry out the delivery box B1 to and from the second conveyance path 63. The configuration of the branch conveyance roller 33 is the same as that of a first turning conveyance path 53B, which will be described in detail later, and thus a detailed description is omitted here.

The sorting station 5 constitutes the work location 55 where the sorting work of articles by the operator is performed. The sorting station 5 includes a lower buffer line 51, an upper buffer line 61, and a lifter 71.

The lower buffer line 51 includes a first conveyance path 53 of a loop shape and configured to convey the delivery box B1 in one direction. In the lower buffer line 51, a portion of the first conveyance path 53 is provided with the work location 55 where the operator performs the sorting work. The first conveyance path 53 includes a first linear conveyance path 53A and a first turning conveyance path 53B. The first linear conveyance path 53A supports the bottom surface of the delivery box B1 from below and conveys the delivery box B1 only in one direction. The type of the first linear conveyance path 53A is not particularly limited, and is, for example, a roller conveyor or a belt conveyor.

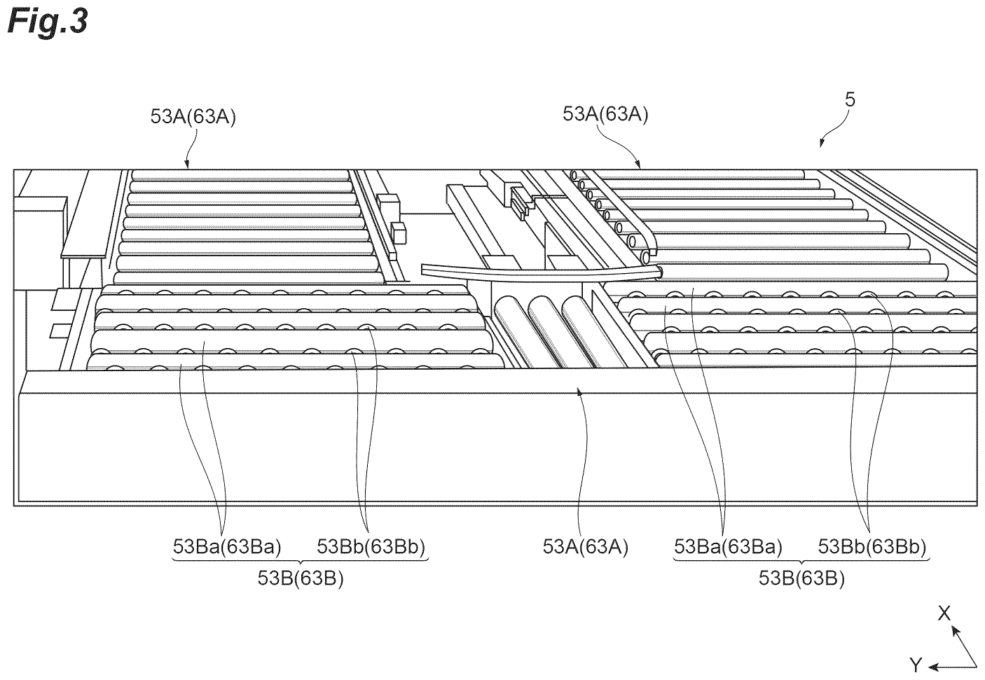

The first turning conveyance path 53B conveys the delivery box B1 along one direction (X direction) and also switches the conveyance direction to a direction (Y direction) orthogonal to the one direction to convey the delivery box B1. More particularly, as illustrated in FIG. 3, the first turning conveyance path 53B includes long rollers 53Ba and rotating rollers 53Bb. The long rollers 53Ba are arranged along the conveyance direction (X direction) of the delivery box B1. A plurality of the rotating rollers 53Bb are arranged between the adjacent ones of the long rollers 53Ba and 53Ba along the direction of extension (Y direction) of the long rollers 53Ba.

The long roller 53Ba is provided in a movable manner in an up-and-down direction between an advance position at a first height and a retreat position at a second height lower than the first height. When the long rollers 53Ba is positioned in a retreat position, the first turning conveyance path 53B allows the long rollers 53Ba to be disposed such that the height position of the rotating roller 53Bb (the position at which the delivery box B1 is supported from below) is higher than that of the long roller 53Ba (the position at which the delivery box B1 is supported from below).

The first turning conveyance path 53B allows the delivery box B1 to be conveyed in the X direction by rotating and driving all the long rollers 53Ba or some of the long rollers 53Ba with the long rollers 53Ba positioned in their normal positions. The first turning conveyance path 53B allows the delivery box B1 to be conveyed in the Y direction by rotating and driving the rotary roller 53Bb with the long roller 53Ba positioned in the retreat position. In other words, the first turning conveyance path 53B allows the delivery box B1 to move in both the Y and X directions.

As illustrated in FIGS. 1 and 2, the work location 55 is a location where the sorting work of articles by the operator is performed, as described above. More precisely, there is a stop position for the delivery box B1, and a space for the operator to perform the operation is disposed in the vicinity thereof. A terminal device 81 and a completion button to submit completion of the operation may be placed at the work location 55. On a display unit (display) of the terminal device 81, the type of goods (goods name) and the number of the goods to be fed into the delivery box B1 by the operator based on the order described above are displayed. Based on the contents displayed on the display unit of the terminal device 81, the operator feeds the goods into the delivery box B1 that is being conveyed, and presses the completion button. When the completion button is pressed, the display unit displays the type of goods and the number of the goods to be fed into the delivery box B1 next. In the present example embodiment, the work location 55 is provided below (directly below) a portion extending linearly in the Y direction in the main conveyor 3.

The upper buffer line 61 has the second conveyance path 63 configured to convey the delivery box B1 in one direction from one end to another end. The second conveyance path 63 has one end 61a and another end 61b that are connected to the main conveyor 3. In the second conveyance path 63 in the present example embodiment, the upper buffer line 61 preferably is U-shaped or substantially U-shaped in plan view viewed from the vertical direction is provided above the lower buffer line 51. In the present example embodiment, the lower buffer line 51 and the upper buffer line 61 are provided such that the first conveyance path 53 and the second conveyance path 63 overlap in plan view.

The second conveyance path 63 includes a second straight conveyance path 63A and a second turning conveyance path 63B. The second linear conveyance path 63A supports the bottom surface of the delivery box B1 from below and conveys the delivery box B1 only in one direction. The type of the second straight conveyance path 63A is not particularly limited, and is, for example, a roller conveyor, a belt conveyor, or the like. The second turning conveyance path 63B conveys the delivery box B1 along one direction (X direction) and also switches the conveyance direction to a direction (Y direction) orthogonal to one direction to convey the delivery box B1. More precisely, as illustrated in FIG. 3, the second turning conveyance path 63B has long rollers 63Ba and rotating rollers 63Bb. The long rollers 63Ba are arranged along the conveyance direction (X direction) of the delivery box B1. A plurality of the rotating rollers 63Bb are arranged between the adjacent ones of the long rollers 63Ba and 63Ba along the direction of extension (Y direction) of the long rollers 63Ba. The configuration of the second turning conveyance path 63B, in which the delivery box B1 can be moved in both the Y and X directions, is the same as that of the first turning conveyance path 53B, and thus a detailed description is omitted here.

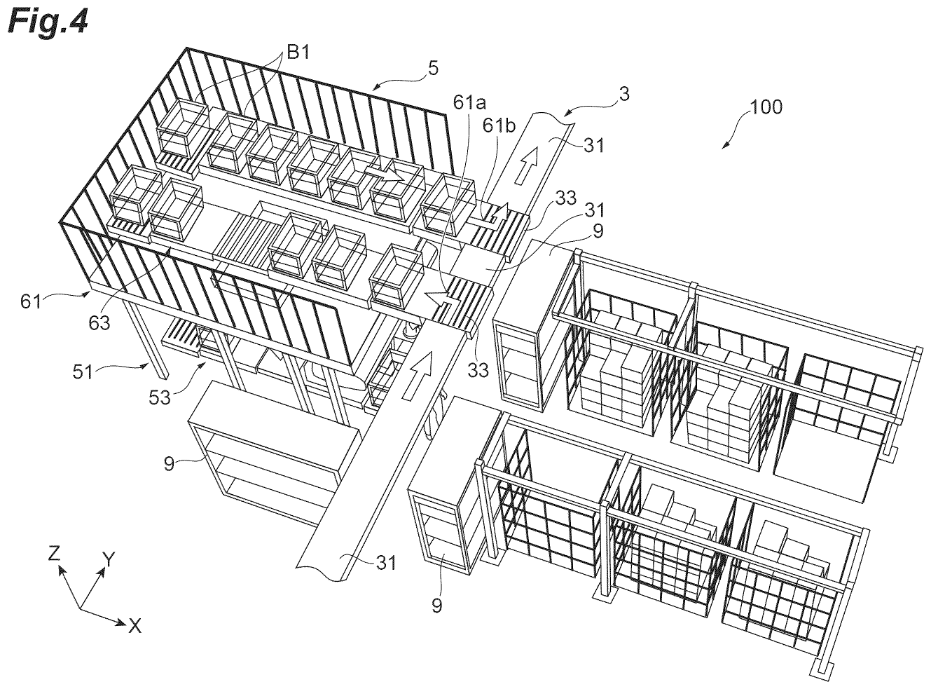

As illustrated in FIGS. 1 to 5, the lifter 71 conveys the delivery box B1 in the vertical direction to allow the delivery box B1 to be passed between the first conveyance paths 53 and the second conveyance path 63. In the present example embodiment, the lifter 71 is disposed slightly on a downstream side of the one end 61a of the second conveyance path 63. The position at which the lifter 71 is disposed is not limited thereto, and is not particularly limited as long as it is possible to carry in and carry out the delivery box B1 to and from the second conveyance path 63 and the first conveyance path 53. The lifter 71 includes a movable body 73, a movable body drive unit (driver) 75, a conveyance roller 77, and a conveyance drive unit 79. The movable body 73 is provided in a movable manner in the up-and-down direction, and is moved in the up-and-down direction when the driving force of the movable body drive unit 75 is transmitted to the movable body 73. The movable body drive unit 75 is disposed in the area surrounded by the first conveyance path 53 of a loop shape.

A plurality of the conveyance rollers 77 are disposed on the movable body 73. Some or all of the plurality of conveyance rollers 77 are drive wheels driven by the conveyance drive unit 79. The conveyance rollers 77 rotate when the driving force of the conveyance drive unit 79 is transmitted to the drive wheels, and the delivery box B1 is carried in from the first conveyance path 53 or the second conveyance path 63 to a center portion of the movable body 73. Similarly, the conveyance rollers 77 rotate when the driving force of the conveyance drive unit 79 is transmitted to the drive wheels, and the delivery box B1 is carried out from the center portion of the movable body 73 to the first conveyance path 53 or the second conveyance path 63. The movable body 73 moves in the Z direction with the delivery box B1 positioned in the center portion of the movable body. The conveyance drive unit 79 is provided to a frame of the movable body 73.

In the present example embodiment, the operation of carrying in the delivery box B1 from the first conveyance path 53 to the lifter 71 and the operation of carrying out the delivery box B1 from the lifter 71 to the first conveyance path 53 are performed simultaneously. The operation of carrying in the delivery box B1 from the second conveyance path 63 to the lifter 71 and the operation of carrying out the delivery box B1 from the lifter 71 to the second conveyance path 63 are performed simultaneously. In the present example embodiment, the direction of carrying in the delivery box B1 from the first conveyance path 53 to the lifter 71 coincides with the direction of carrying out the delivery box B1 from the lifter 71 to the first conveyance path 53, and the direction of carrying the delivery box B1 from the second conveyance path 63 to the lifter 71 coincide with the direction of carrying out the delivery box B1 from the lifter 71 to the second conveyance path 63. In FIGS. 1 and 2, the lifter 71 is illustrated in a box shape along the direction of movement of the movable body 73, but such a cover-like housing may or may not be provided.

The operation of carrying in the delivery box B1 from the first conveyance path 53 to the lifter 71 may be performed successively with the operation of carrying out the delivery box B1 from the lifter 71 to the first conveyance path 53. The operation of carrying in the delivery box B1 from the second conveyance path 63 to the lifter 71 may be performed successively with the operation of carrying out the delivery box B1 from the lifter 71 to the second conveyance path 63.

The movement of delivery box B1 at the sorting station 5 as described above will now be explained. As illustrated in FIGS. 1 and 2, the delivery box B1 carried in from the main conveyor 3 are conveyed on the second conveyance path 63 to the lifter 71. The delivery box B1 conveyed to the lifter 71 is conveyed downward by the lifter 71 and is carried out to the first conveyance path 53. The delivery box B1 carried out to the first conveyance path 53 are conveyed to the work location 55, and articles based on orders are put into the delivery box B1 by the operator at the work location 55. The delivery box B1 is then conveyed by the first conveyance path 53 to the lifter 71. The delivery box B1 conveyed to the lifter 71 is conveyed upward by the lifter 71 and is carried out to the second conveyance path 63. The delivery box B1 carried out to the second conveyance path 63 is conveyed to the other end 61b of the second conveyance path 63 and is carried out to the main conveyor 3.

The effects of the action of the sorting station 5 in the above example embodiment will be described. As illustrated in FIGS. 1 and 2, in the sorting station 5 of the above example embodiment, the delivery boxes B1 to be sorted can be stored separately in the upper buffer line 61 and the lower buffer line 51, and thus the storage capacity for delivery boxes B1 to be sorted can be secured. In this configuration, the work location 55 where the operator performs the sorting work is provided on the lower buffer line 51, and the lower buffer line 51 is provided at a different level (height position) from the upper buffer line 61 to which the main conveyor 3 is connected, and thus the main conveyor 3 is disposed at a different level from the work location 55. With this configuration, the space around the work location 55 of the operator performing the sorting work is no longer restricted by the main conveyor 3, and thus the space around the work location 55 can be more widely secured.

In the sorting station 5 of the above example embodiment, the second conveyance path 63 preferably is U-shaped or substantially U-shaped in plan view, and thus the storage capacity for the delivery box B1 can be secured while space saving is secured.

In the sorting station 5 of the above example embodiment, the movable body drive unit 75 of the lifter 71 is disposed in the area surrounded by the first conveyance path 53 of a loop shape. With this configuration, the movable body drive unit 75 can be disposed by using a dead space surrounded by the first conveyance path 53 of a loop shape. As a result, it is possible to prevent the space around the work location 55 from being restricted by the movable body drive unit 75.

In the sorting station 5 of the above example embodiment, the operation of carrying in the delivery box B1 from the first conveyance path 53 to the lifter 71 is performed simultaneously with the operation of carrying out the delivery box B1 from the lifter 71 to the first conveyance path 53, and the operation of carrying in the delivery box B1 from the second conveyance path 63 to the lifter 71 is performed simultaneously with the operation of carrying out the delivery box B1 from the lifter 71 to the second conveyance path 63. With this configuration, a time required for conveying the delivery box B1 to the lifter 71 and a time required for conveying the delivery box B1 from the lifter 71 can be reduced. Such an operation can also effectively increase the capacity of the conveyance process in a configuration including only one unit of lifter configured to connect the first conveyance path 53 and the second conveyance path 63. The operation of carrying in the delivery box B1 from the first conveyance path 53 to the lifter 71 may be performed successively (continuously) with the operation of carrying out the delivery box B1 from the lifter 71 to the first conveyance path 53, and the operation of carrying in the delivery box B1 from the second conveyance path 63 to the lifter 71 may be performed successively (continuously) with the operation of carrying out the delivery box B1 from the lifter 71 to the second conveyance path 63.

In the sorting station 5 of the above example embodiment, the work location 55 in the lower buffer line 51 is provided below a portion of the main conveyor 3, the portion extending linearly in one direction, and thus a line of movement can be secured along which the operator moves below the main conveyor 3 disposed linearly.

In the above example embodiment, explanation is made with an example in which the articles based on orders are put in the delivery box B1 by the operator at the work location 55, but articles based on orders may also be picked from the delivery box B1 by the operator. Even in this case, it is possible to provide a sorting station capable of securing a wide space around the work location where the operator performs the sorting work, and capable of securing the storage capacity for conveyed item to be picked.

Although example embodiments are described above, the present invention is not limited to the above example embodiments. Various changes can be made without departing from the gist of the present invention.

### Modification 1

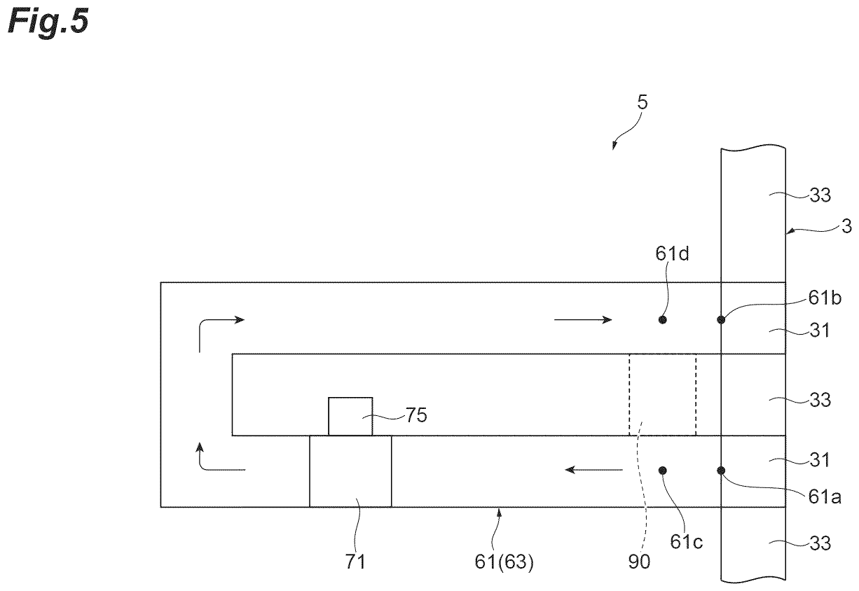

In the sorting station 5 of the above example embodiments, explanation is made with an example in which the second conveyance path 63 of the upper buffer line 61 preferably is U-shaped or substantially U-shaped in plan view, but in addition to this configuration, the upper buffer line 61 may have a connecting conveyance path 90 as illustrated in FIG. 5. The second conveyance path 63 conveys the delivery box B1 in one direction from one end 61a to other end 61b, and the one end 61a and the other end 61b are connected to the main conveyor 3. The connecting conveyance path 90 connects a first relay section 61c on a downstream side of the one end 61a in the second conveyance path 63 to a second relay section 61d on an upstream side of the other end 61b in the second conveyance path 63. The configuration of the first relay section 61c and the second relay section 61d is the same as that of the first turning conveyance path 53B.

In the sorting station 5 according to Modification 1, the delivery box B1 accommodating articles to be sorted in sorting work by the operator can be conveyed again to the work location 55, by being conveyed from the second relay section 61d to the first relay section 61c through the connecting conveyance path 69, without being returned to the main conveyor 3 from the other end 61b. With this configuration, the throughput of the sorting work can be improved.

### Modification 2

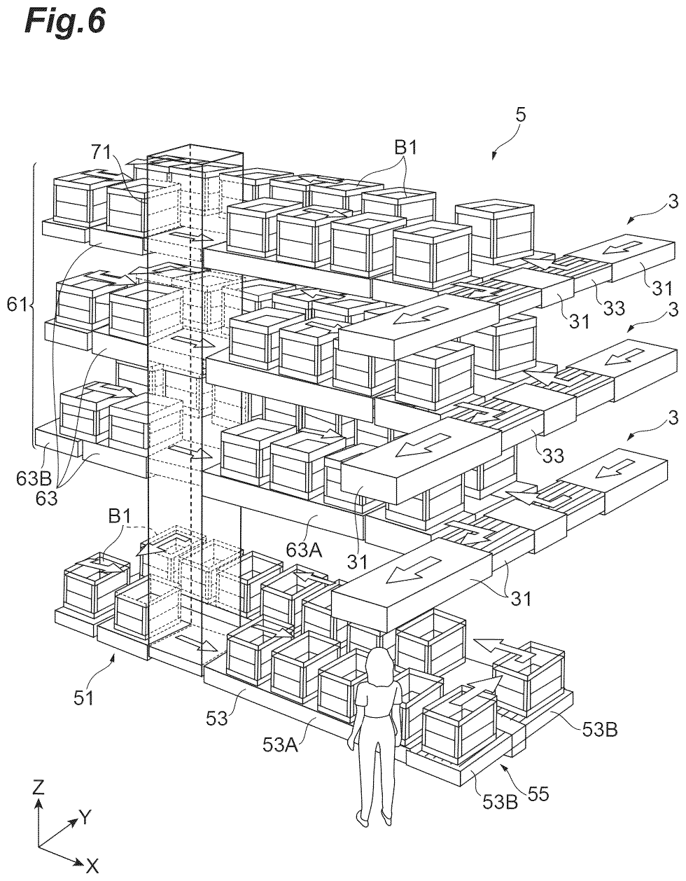

In the sorting station 5 of the above example embodiments and Modification 1, explanation is made with an example in which the upper buffer line 61 is configured as a single layer, but it may be configured as multiple layers, for example, as illustrated in FIG. 6. In other words, the second conveyance paths 63 constituting the upper buffer line 61 may be arranged in the vertical direction (Z direction), and may be provided with the lifter 71 configured to allow the delivery box B1 to be passed between the plurality of second conveyance paths 63 and the first conveyance path 53.

### Modification 3

In the sorting station 5 of the above example embodiments and Modification 2, explanation is made with an example in which the delivery box B1 in which articles based on orders are to be accommodated at the work location 55 is used such that the delivery box B1 circulates through various portions of the sorting station 5. An article box B2 accommodating a plurality of articles to be taken out at the work location 55 may be used such that the article box B2 circulates through various portions of the sorting station 5. In this case, Modification 3 can be configured as a picking system 100 including the above sorting station 5, the main conveyor 3, and an article box warehouse 1 where the delivery boxes B2 are stored.

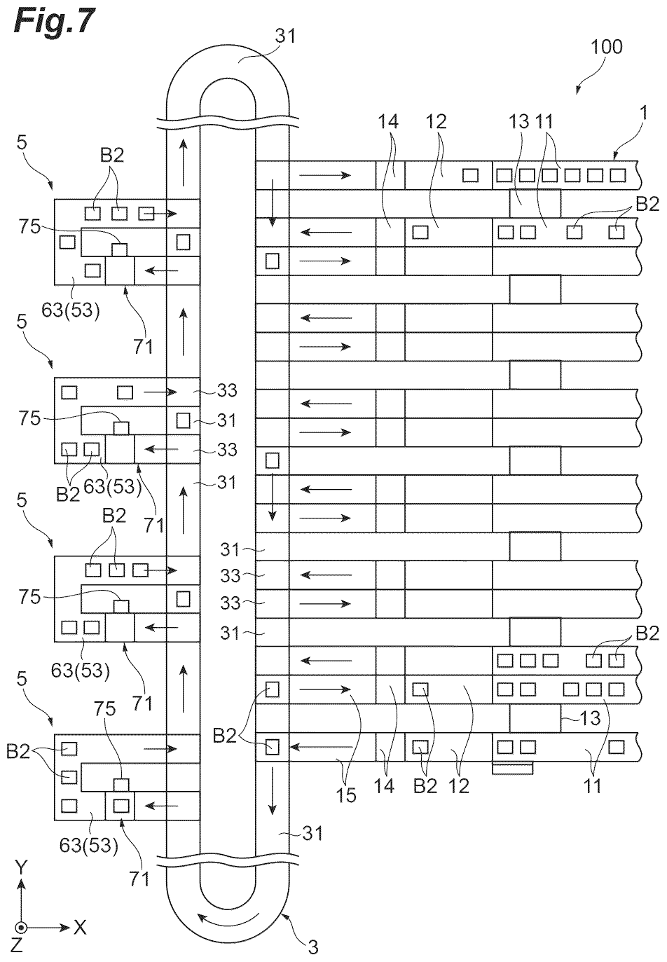

As illustrated in FIG. 7, the picking system 100 is a system configured to support a sorting work (picking) for taking out articles of types and quantities that match orders of shipping destinations from the respective article box warehouses (storage sections) 1 provided for each type of article, and consolidating and accommodating the articles in a delivery box (container). More specifically, the picking system 100 conveys the article boxes B2 in which goods are accommodated from a corresponding one of the article box warehouses 1 storing goods to the sorting station 5. At the sorting station 5, the sorting work for taking out, from the article box B2 having been conveyed thereto, goods of types and quantities based on orders and accommodating the goods in the delivery box is performed by the operator. The picking system 100 conveys the article box B2 from which the goods have been taken out at the sorting station 5 to the article box warehouse 1 from which the article box B2 has been unloaded, and re-enters the article box B2 in the article box warehouse 1.

The article box warehouse 1 is an automated warehouse capable of storing the plurality of article boxes B2 accommodating different types of articles by type, unloading the article boxes B2 based on orders, re-entering the article boxes B2, which are returned after unloading, in the article box warehouse 1, and storing the article boxes B2 again. Although a type of the article box warehouse 1 is not particularly limited, the article box warehouse 1 of Modification 3 includes a first rack 11, a first conveyor 12, a first conveyor 13, a vertical conveyor 14, and a second conveyor 15.

The first rack 11 is a shelf for storing the article boxes B2. In Modification 3, the first rack 11 is provided so as to be able to place the plurality of article boxes B2 thereon along one direction in the horizontal direction (X direction illustrated in FIG. 7). A plurality of tiers of the first racks 11 are arranged along the vertical direction (Z direction illustrated in FIG. 2). The first racks 11 are arranged facing each other across the first conveyor 13 in a direction (Y direction illustrated in FIG. 7) orthogonal to the direction of extension (X direction) of the first rack 11. The picking system 100 may include a plurality of article box warehouses 1 that store the same type of article boxes B2. The number of the article box warehouses 1 included in the picking system 100 is not particularly limited. A type or a size (the number of article boxes B2 to be stored, or the like) of the article box warehouse 1 is not particularly limited, and types or sizes of the plurality of article box warehouses 1 may differ from each other.

The first conveyor 13 transfers the article boxes B2 passed from the first rack 11 and the first conveyor 12 to another location on the first rack 11 and the first conveyor 12. The type of the first conveyor 13 is not particularly limited, and is, for example, a stacker crane including a transfer device capable of traveling along the extended direction of the first rack 11 and conveying the article boxes B2 to the respective loading areas of the first rack 11 and the first conveyor 12. The first conveyor 13 may be a conveyor including rails, each of which is laid at a position corresponding to each tier of the first rack 11, and a cart disposed for each rail. The rails extend along the first rack 11 to the first conveyor 12, and the cart reciprocates along the rails while holding the article box B2. The cart includes a conveying device capable of conveying the article boxes B2 between the first rack 11 and the cart and between the first conveyor 12 and the cart.

The first conveyor 12 is disposed at a position corresponding to each tier of a pair of the first racks 11, 11. One first conveyor 12 conveys the article box B2 along the direction of extension of one first rack 11 and carries out the article box B2 to the vertical conveyor 14. The other first conveyor 12 conveys the article boxes B2 along the direction of extension of the other first rack 11 and passes, to the first conveyor 13, the article boxes B2 carried in from the vertical conveyor 14. A type of the first conveyor 12 is not particularly limited, and is, for example, a roller conveyor or a belt conveyor.

The vertical conveyor 14 conveys the article boxes B2 along the vertical direction (Z direction). In the present example embodiment, a pair of the vertical conveyors 14, 14 respectively corresponding to the pair of first conveyors 12, 12 are provided. One vertical conveyor 14 conveys the article boxes B2 carried in from the first conveyor 12 along the vertical direction and carries out the article boxes B2 to the second conveyor 15. The other vertical conveyor 14 conveys in the Z direction the article boxes B2 carried in from the second conveyor 15 and carries out the article boxes B2 to the first conveyor 12 at a predetermined tier.

The second conveyor 15 conveys the article boxes B2 in the X direction between the main conveyor 3 and the vertical conveyor 14. In the present example embodiment, a pair of the second conveyors 15, 15 respectively corresponding to the pair of vertical conveyors 14, 14 are provided. One second conveyor 15 conveys the article boxes B2 carried in from the vertical conveyor 14 in the X direction and carries out the article boxes B2 to the main conveyor 3. The other second conveyor 15 conveys the article boxes B2 carried in from the main conveyor 3 in the X direction and carries out the article boxes B2 to the vertical conveyor 14.

The main conveyor 3 conveys the unloaded (passed) article boxes B2 from the article box warehouse 1 to each sorting station 5 and also conveys the article boxes B2 carried out from each sorting station 5 to the article box warehouse 1. The configuration of the main conveyor 3 is the same as in the above example embodiments, and thus a detailed description is omitted here. The sorting station 5 constitutes the work location 55 where the sorting work of articles by the operator is performed. The configuration of the sorting station 5 is the same as in the above example embodiments, and thus a detailed description is omitted here. At the sorting station 5 having such a configuration, the operator takes out an article displayed on the display unit of the terminal device 81 from the article box B2 at the work location 55 and puts the article that has been taken out into the delivery box B1. At the sorting station 5 like this, the operator can perform the sorting work for accommodating articles of types and quantities that match orders of shipping destinations in the delivery box B1.

### Other Modifications

The lifter 71 provided in the sorting station 5 in the above example embodiments and the modifications is explained with an example having a configuration in which only one delivery box B1 (article box B2) can be conveyed at a time, but the lifter 71 may be provided to have a configuration in which a plurality of the delivery boxes B1 (article boxes B2) can be conveyed simultaneously. Specifically, the movable body 73 may be configured to be long enough to place the plurality of delivery boxes B1 (article boxes B2), and thereby the plurality of delivery boxes B1 (article boxes B2) can be conveyed simultaneously.

In the sorting station 5 of the above example embodiments and the modifications, explanation is made by using a roller conveyor as an example of the main conveyor 3, but it can be a belt conveyor or a tracked cart. An example of the main conveyor 3 may be a conveyance cart such as a stacker crane that exchanges an article with a shelf where the articles are stored.

While example embodiments of the present invention have been described above, it is to be understood that variations and modifications will be apparent to those skilled in the art without departing from the scope and spirit of the present invention. The scope of the present invention, therefore, is to be determined solely by the following claims.

1-8. (canceled)

9. A sorting station where sorting work is performed on a conveyed item by an operator, the sorting station comprising:
a lower buffer line including a loop-shaped first conveyance path to convey the conveyed item in one direction and including a work location where the operator is able to perform sorting work;
an upper buffer line provided above the first conveyance path and including a second conveyance path to convey the conveyed item from a first end to a second end in one direction, the first end and the second end being connected to a main conveyor to convey the conveyed item; and
a lifter to convey the conveyed item in a vertical direction to allow the conveyed item to be passed between the first conveyance path and the second conveyance path.

10. The sorting station according to claim 9, wherein the second conveyance path is U-shaped or substantially U-shaped in plan view viewed from the vertical direction.

11. The sorting station according to claim 9, wherein a driver of the lifter is in an area surrounded by the loop-shaped first conveyance path.

12. The sorting station according to claim 9, wherein the upper buffer line includes a connecting conveyance path to connect a first relay section on a downstream side of the first end in the second conveyance path to a second relay section on a downstream side of the first relay section and on an upstream side of the second end in the second conveyance path.

13. The sorting station according to claim 9, wherein an operation of conveying the conveyed item from the first conveyance path to the lifter and a conveyance operation of conveying out the conveyed item from the lifter to the first conveyance path are executed simultaneously, and an operation of conveying in the conveyed item from the second conveyance path to the lifter and an operation of conveying out the conveyed item from the lifter to the second conveyance path are executed simultaneously.

14. The sorting station according to claim 9, wherein a plurality of the upper buffer lines are provided in a plurality of layers in the vertical direction.

15. The sorting station according to claim 9, wherein the lifter is operable to allow a plurality of the conveyed item to be conveyed simultaneously.

16. The sorting station according to claim 9, wherein the work location in the lower buffer line is provided below a portion of the main conveyor extending linearly in one direction.
